(19) United States
(12) Patent Application Publication
(10) Pub. No.: US 2025/0253464 A1
(43) Pub. Date: Aug. 7, 2025

(54) PROTECTIVE ELEMENT, ENERGY STORAGE DEVICE, AND MOTOR VEHICLE

(71) Applicant: ElringKlinger AG, Dettingen (DE)

(72) Inventors: Robert WITZGALL, Reutlingen (DE); Harri DITTMAR, Grünenbach (DE)

(73) Assignee: ElringKlinger AG, Dettingen (DE)

(21) Appl. No.: 19/189,744

(22) Filed: Apr. 25, 2025

Related U.S. Application Data
(63) Continuation of application No. PCT/EP2023/079695, filed on Oct. 25, 2023.

(30) Foreign Application Priority Data
Oct. 28, 2022 (DE) 10 2022 128 721.1

(51) Int. Cl. H01M 50/24; H01M 50/249; H01M 50/276; H01M 50/28; H01M 50/282

(52) U.S. Cl. CPC H01M 50/24; H01M 50/276; H01M 50/28; H01M 50/282; H01M 50/249; H01M 2220/20

(57) ABSTRACT

A protective element (114) for an electrochemical energy storage unit (102), e.g. for a battery cell (104), wherein the protective element (114) comprises the following: a protective layer (116), e.g. a hot gas particle stream abrasion protection layer (118), wherein the protective layer (116) comprises a protective material (120), e.g. a hot gas particle stream abrasion protection material (122).

### RELATED APPLICATION

This application is a continuation of international application No. PCT/EP 2023/079695 filed on Oct. 25, 2023, and claims the benefit of German application No. 10 2022 128 721.1 filed on Oct. 28, 2022, which are incorporated herein by reference in their entirety and for all purposes.

### FIELD OF DISCLOSURE

The present invention relates to the technical field of fire protection, in particular fire protection for electrochemical storage systems of electrically driven motor vehicles.

### BACKGROUND

Motor vehicles that are driven entirely or partially electrically comprise electrochemical energy storage units. The electrochemical energy storage units may be battery cells, e.g. rechargeable lithium-ion battery cells.

If a battery cell fails, it may happen that a hot gas with a high particle content may escape from the failing battery cell. Very high temperatures may occur during this process. These may be up to about 1400° C., for example. Such failure of a battery cell is also referred to as thermal runaway.

In the event of the thermal runaway of a battery cell, it is important both to prevent spreading to adjacent battery cells and to protect other component parts of the motor vehicle, especially the passenger compartment, from the heat released and the gases released. This applies not only to lithium-ion battery cells but to all electrochemical energy storage units that can store energy with a high energy density.

It is the underlying object of the present invention to provide an energy storage device and/or a motor vehicle as well as components suitable therefor, whereby the safety of people, e.g. motor vehicle occupants, in the event of a thermal runaway of an electrochemical energy storage unit can be reliably ensured or improved, and to do so at little expense (to provide the component in a single-stage process, for example). In particular, it is possible, by means of the energy storage device and/or the motor vehicle as well as the component suitable therefor, to simultaneously achieve better electromagnetic compatibility and/or a low weight in combination with good mechanical properties and/or good recycling options.

### SUMMARY OF THE INVENTION

This object is achieved by a protective element according to the invention as claimed in the relevant independent claim.

The protective element is a protective element for an electrochemical energy storage unit. The electrochemical energy storage unit may be a battery cell, for example. In particular, the battery cell may be a rechargeable lithium-ion battery cell.

The electrochemical energy storage unit may have any desired shape. In particular, it may be cylindrical, prismatic or in the form of a bag. In particular, the battery cell may be a cylindrical battery cell, a prismatic battery cell or a bag-shaped battery cell (so-called pouch cell).

The protective element comprises a protective layer. The protective layer may be, for example, a hot gas particle stream abrasion protection layer. In particular, the hot gas particle stream abrasion protection layer can be a protective layer which offers abrasion protection from a particle stream carried by a hot gas. In particular, it can offer abrasion protection against the particle stream, carried by a hot gas, which escapes from the battery cell during the thermal runaway of a battery cell.

The protective layer comprises a protective material. The protective material may be, for example, a hot gas particle stream abrasion protection material.

In particular, the hot gas particle stream abrasion protection material can be a protective material which offers abrasion protection from a particle stream carried by a hot gas. In particular, it can offer abrasion protection against the particle stream, carried by a hot gas, which escapes from the battery cell during the thermal runaway of a battery cell.

It may be advantageous if the protective material contains protective fibers. The protective fibers can be, in particular, protective fibers which are resistant to a hot gas particle stream.

The protective fibers are preferably high-temperature-stable. The high-temperature-stable protective fibers are preferably stable at a melting temperature of glass fibers, which can be 1150° C., for example.

It may be advantageous if the high-temperature-stable protective fibers are stable at a melting temperature of glass fibers, which can be 1200° C., for example.

It may furthermore be advantageous if the high-temperature-stable protective fibers are stable at a melting temperature of glass fibers, which can be 1230° C., for example.

It may be particularly advantageous if the high-temperature-stable protective fibers are stable at a melting temperature of glass fibers, which can be 1275° C., for example.

It may be very particularly advantageous if the high-temperature-stable protective fibers are stable at a melting temperature of glass fibers, which can be 1310° C., for example.

It may be extremely advantageous if the high-temperature-stable protective fibers are stable at a melting temperature of glass fibers, which can be 1340° C., for example.

It may be, for example, that the high-temperature-stable protective fibers are stable at a melting temperature of glass fibers, which can be 1400° C., for example.

Reference is made here in each case for the sake of illustration to melting temperatures of glass fibers, which may differ depending on the glass composition thereof, only because glass fibers are widely available reinforcing materials, which are added to plastics, for example. Glass-reinforced plastics (“GRP”) are widely available, as is known.

The high-temperature-stable protective fibers are preferably stable at 1150° C., advantageously at 1200° C., further advantageously at 1230° C., particularly advantageously at 1275° C., very particularly advantageously at 1310° C., and extremely advantageously at 1340° C., e.g. at 1400° C.

In this context, “stable” can mean, in particular, flame-resistant. In particular, the temperature stability described herein can be, in particular, flame resistance.

It is possible to test whether the high-temperature-stable protective fibers are stable at one of the temperatures mentioned here by positioning a woven fabric produced from the high-temperature-stable protective fibers in a flame in such a way that the respective temperature is established at the surface of the woven fabric. In particular, the high-temperature-stable protective fibers can be regarded as stable at the respective temperature if the woven fabric withstands the flame at a respective surface temperature for a duration of at least 40 seconds, in particular at least 60 seconds. In the context of the invention, this duration may be decisive since, during the thermal runaway of electrochemical energy storage units, the vast majority of the heat released is released within a very short time. It may therefore be assumed that a protective fiber which can withstand exposure to heat for a duration of 40 seconds, preferably 60 seconds, can also withstand the exposure to heat associated with the thermal runaway.

The protective fibers can advantageously be selected from among mineral fibers, carbon fibers and aramid fibers.

It may be particularly advantageous if the protective fibers are selected from among mineral fibers and carbon fibers.

Many different mineral fibers are high-temperature-stable.

The mineral fibers can preferably be selected from among
fibers made from a glass,
fibers made from rock,
fibers made from slag,
silica fibers,
fibrous single crystals, and
ceramic fibers.

Fibers made from rock are known to those skilled in the art from the technical field of mineral wool.

Fibers made from slag can be obtained as a byproduct of ore smelting. In metallurgy, the term “slag” refers to the nonmetallic gangue phases, which solidify in glassy or crystalline form.

Silica fibers are also known to those skilled in the art. They can be obtained by washing out E-glass.

Fibrous single crystals are also referred to as whiskers or hair-like crystals. These may, for example, be acicular single crystals measuring a few micrometers in diameter and up to several hundred micrometers to several millimeters in length.

Ceramic fibers refer to all oxidic or nonoxidic amorphous or polycrystalline nonmetallic inorganic fibers that are not produced from glass melts. They can contain alumina, silica sand, boron oxide and zirconium oxide.

It may be particularly advantageous if the mineral fibers are selected from among
fibers made from at least one of the following glasses:
S-glass,
R-glass,
C-glass,
ECR-glass,
AR-glass and
Q-glass
   and
basalt fibers.

The terms S-glass, R-glass, C-glass, ECR-glass, AR-glass and Q-glass are known to those skilled in the art. An S-glass can be, in particular, an aluminum silicate glass with added magnesium oxide. S-glasses are known for meeting high mechanical requirements, even at high temperatures. An R-glass can be, in particular, an aluminum silicate glass with added calcium and magnesium oxide. R-glasses are also known for meeting high mechanical requirements, even at high temperatures. A C-glass can contain, in particular, boron trioxide. C-glasses are known for their high chemical resistance. A Q-glass is, in particular, a quartz glass. Q-glasses are suitable, in particular, for uses at high temperatures of up to 1450° C.

It may be particularly advantageous if the protective fibers are selected from among recycled carbon fibers.

The recycled carbon fibers can advantageously come from comminuted and/or shredded non-crimp scraps, woven fabric scraps or knitted fabric scraps, comminuted and/or shredded waste threads, leftover rovings, edge trimmings from non-crimp fabric production or leftover bobbin-wound material, prepreg waste that has been comminuted and/or shredded and/or waste pretreated thermally or with a solvent, or resin-containing waste that has been comminuted and/or shredded and treated thermally or with a solvent, hard CFRP parts and old parts.

If the protective fibers are selected from among carbon fibers, this may result in advantages, in particular also in respect of electromagnetic compatibility (EMC). EMC refers to the lack of interference between electrical or electronic devices and their environment. Modern motor vehicles are incorporating more and more devices that communicate via electromagnetic waves. As a result, ensuring EMC is becoming an increasing challenge. Tests indicate that electromagnetic compatibility in the range above 10MHz can be improved by the use of carbon fibers as protective fibers.

It may be advantageous if at least some of the protective fibers do not reach as far as at least one surface of the protective element. This applies especially if the protective fibers are electrically conductive, e.g. if the protective fibers are carbon fibers. The protective fibers at the surface may advantageously be covered by an insulation zone.

The insulation zone can provide protection, in particular, from contact with oxygen and from the risk of an electric arc effect which may exist on account of the electrical conductivity of the carbon fibers.

The insulation zone can, for example, be formed by part of a fiber protection matrix, into which at least some of the protective fibers, which are carbon fibers for example, are incorporated.

However, the use of the abovementioned mineral fibers and/or carbon fibers as protective fibers also opens up the possibility of particularly efficient single-stage production of protective elements. These fibers can, for example, be introduced directly as a fiber reinforcement into a plastic melt, from which fiber-reinforced protective elements can be directly manufactured. These and other protective elements according to the invention can furthermore be recycled with little effort.

In addition to the protective fibers, the protective element can preferably contain additional fibers.

The temperature stability of the additional fibers can preferably be lower than the temperature stability of the protective fibers.

The temperature stability of the additional fibers can preferably be around at least 50 K, as a further preference at least 110 K, e.g. at least 180 K, less than the temperature stability of the protective fibers.

However, it may also be advantageous if the additional fibers also have a certain temperature stability.

Thus, the temperature stability of the additional fibers can preferably be at most 1200 K, preferably at most 850 K, e.g. at most 550 K, less than the temperature stability of the protective fibers.

In particular, it may advantageously be the case that the additional fibers are glass fibers.

At least some of the additional fibers can be made from E-glass and/or ECR-glass. The additional fibers can advantageously be made from E-glass. E-glass fibers are regarded as standard fibers for general reinforcement of plastics.

The ratio of protective fibers to additional fibers in terms of mass can vary within wide ranges. For example, it may be in a range of from 50:1 to 1:50, in particular in the range of from 10:1 to 1:10, preferably in the range of from 5:1 to 1:5, e.g. in the range of from 3:1 to 1:3

It may be advantageous if the protective layer is a fiber layer.

Here, a fiber layer preferably refers to a layer in which the fibers form a coherent sheet-like fibrous structure.

The fiber layer can preferably contain the protective fibers contained in the protective material.

The fiber layer can preferably contain some of the protective fibers contained in the protective material.

The fiber layer can comprise the additional fibers.

The fiber layer can comprise some of the additional fibers.

In addition to the protective layer, which can be a fiber layer for example, the protective element can comprise an additional fiber layer. The additional fiber layer can preferably comprise at least some of the additional fibers.

The protective layer, e.g. the fiber layer, can preferably comprise a regular sheet-like fibrous structure or an irregular sheet-like fibrous structure.

The sheet-like fibrous structure can preferably contain the protective fibers contained in the protective material, e.g. the protective fibers which are resistant to a hot gas particle stream.

The sheet-like fibrous structure can preferably contain some of the protective fibers contained in the protective material, e.g. some of the protective fibers which are resistant to a hot gas particle stream.

In regular sheet-like fibrous structures, at least some of the fibers contained therein are arranged in a regular pattern. Non-crimp fabrics, woven fabrics and knitted fabrics are examples of regular sheet-like fibrous structures.

Mats and nonwovens are examples of irregular sheet-like fibrous structures.

It may be advantageous if the protective layer, e.g. the fiber layer, comprises a non-crimp fabric, a woven fabric, a knitted fabric, a mat or a nonwoven.

The non-crimp fabric, the woven fabric, the knitted fabric, the mat or the nonwoven can preferably contain the protective fibers contained in the protective material, e.g. the protective fibers which are resistant to a hot gas particle stream.

The non-crimp fabric, the woven fabric, the knitted fabric, the mat or the nonwoven can preferably contain some of the protective fibers contained in the protective material.

It may be particularly advantageous if at least some of the protective material in the protective layer is embedded in a plastic. At least some of the protective fibers in the protective layer can advantageously be embedded in the plastic.

The plastic can preferably be a thermoplastic. It may be particularly advantageous if at least some of the protective fibers in the protective layer are embedded in the thermoplastic.

It may be particularly advantageous if the protective element or the protective layer can be shapable in a heated state.

Thus, for example, the protective element can be shaped in a heated state. The heated stage refers, in particular, to a state in which the thermoplastic can be shaped.

The protective element can preferably comprise an expansion zone. It may be particularly preferred if the protective layer comprises the expansion zone.

The protective element can be expandable in the expansion zone, wherein the protective element can preferably be expandable in the expansion zone by the action of heat.

The protective layer can be expandable in the expansion zone, wherein the protective layer can preferably be expandable in the expansion zone by the action of heat.

The term “expandable” preferably refers herein to expandability in the thickness direction of the protective element.

The thickness direction extends orthogonally to the central plane of the protective layer.

The protective element can thus be expandable in the expansion zone, in particular, in a thickness direction of the protective element, wherein the protective element can preferably be expandable in the thickness direction by the action of heat.

The protective layer can be expandable in the expansion zone in a thickness direction of the protective element, wherein the protective layer can preferably be expandable in the thickness direction by the action of heat.

The action of heat refers, in particular, to the effect of a hot gas stream which escapes from an electrochemical energy storage unit during the thermal runaway. The term “thickness direction” is also used herein as an abbreviated way of referring to the thickness direction of the protective element.

It may be particularly advantageous if the protective element, preferably the protective layer, is held in a compressed state in the thickness direction in the expansion zone. The compressed state can preferably be maintained by a heat-sensitive material. This may be particularly advantageous because the expansion of the protective element, preferably of the protective layer, in the thickness direction can be achievable by the action of heat on the heat-sensitive material.

If the protective layer is kept in the compressed state in the thickness direction in the expansion zone, it may be particularly advantageous if the protective layer comprises the nonwoven.

If the protective layer comprises the nonwoven, the compressed state, e.g. the state of compression in the thickness direction, is preferably maintained by means of the fact that the heat-sensitive material joins together fiber portions of the nonwoven in the compressed state. If the heat-sensitive material joins together fiber portions of the nonwoven, the heat-sensitive material can preferably be in the form of particles.

Alternatively or in addition, if the protective layer comprises the nonwoven, the compressed state, e.g. the state of compression in the thickness direction, is preferably maintained by means of the fact that the heat-sensitive material is passed through the nonwoven in the thickness direction.

The heat-sensitive material can be passed forward and backward in the thickness direction through the nonwoven, for example.

For example, the heat-sensitive material can be passed through the nonwoven in the thickness direction in such a way that portions of the heat-sensitive material extend on the surfaces of the nonwoven. Portions of the heat-sensitive material which extend on the surfaces of the nonwoven can be connected by at least one further portion of the heat-sensitive material, wherein the at least one further portion can extend from one surface of the nonwoven to the other surface of the nonwoven.

If the heat-sensitive material is passed through the nonwoven, e.g. forward and backward in the thickness direction, the heat-sensitive material can preferably be in the form of an elongate element, e.g. in the form of a heat-sensitive thread element. The length of the elongate element is preferably a multiple of the thickness of the nonwoven compressed in the thickness direction.

The heat-sensitive material in the form of the elongate element can be passed alternately forward and backward through the nonwoven in the thickness direction, wherein portions of the elongate element may preferably extend on the surfaces of the nonwoven.

The portions of the heat-sensitive material which extend on the surfaces of the nonwoven may be portions of the elongate element.

This is advantageous since applying a tensile stress to the elongate element then leads to the two surfaces of the nonwoven being moved toward one another, establishing the compressed state of the nonwoven in the thickness direction.

In the compressed state of the nonwoven with heat-sensitive material in particle form, connections between fiber portions can be established in a particularly simple manner by applying particles of the heat-sensitive material to the nonwoven, e.g. by transferring them into the nonwoven by shaking, and then compressing the nonwoven. During compression, heat can be supplied, ensuring that the heat-sensitive material joins together fiber portions, e.g. bonds them together adhesively.

Alternatively or in addition, the protective element can contain an expansion material that can be expanded by the action of heat in the expansion zone. In this case, expansion of the protective element in the thickness direction can be achievable by the action of heat on the expandable expansion material. It is conceivable that the protective layer contains the expansion material that can be expanded by the action of heat in the expansion zone.

It may be advantageous if the expansion material that can be expanded by the action of heat is arranged between the protective layer and the further layer, which may contain the additional fibers described herein, for example.

In principle, many materials may be taken into consideration as expansion materials that can be expanded by the action of heat.

It may be advantageous if the expandable expansion material comprises an encapsulated propellant or consists of the encapsulated propellant.

It may be particularly advantageous if the protective element comprises a heat distributing element. The heat distributing element can preferably be a sheet-like heat distributing element. The sheet-like heat distributing element can be, for example, a sheet-like heat distributing element aligned parallel to the protective layer.

It may be particularly advantageous if the heat distributing element is a metal layer and/or a carbon layer. It may be particularly advantageous if the heat distributing element contains a metal layer and/or a carbon layer.

For example, the heat distributing element can comprise a carbon layer arranged between a plurality of metal layers. For example, the heat distributing element can comprise a metal layer arranged between a plurality of carbon layers. Layer structures of this kind are known to those skilled in the art.

The metal layer can be an aluminum layer, a copper layer or a steel layer, for example. The metal layer can be a sheet-metal layer, for example.

The carbon layer can contain, for example, a graphite expandate partially compressed in the thickness direction. Graphite expandate is also known as expandable graphite. The carbon layer can be or contain a graphite film, for example.

The specific thermal conductivity of the sheet-like heat distributing element in the surface of the heat distributing element is preferably greater than in the thickness direction.

In this case, the heat distributing element preferably is or contains a carbon layer. The carbon layer preferably contains a graphite expandate partially compressed in the thickness direction. The carbon layer can be a graphite film or contain a graphite film, for example.

A specific thermal conductivity of the sheet-like heat distributing element, which is greater in the surface of the heat distributing element than in the thickness direction, is particularly advantageous in the context of the present invention since the large amount of heat which, from a thermally continuous electrochemical energy storage unit, acts in a substantially point-like manner on a surface of the protective element is then distributed, in particular, in the surface. Consequently, a next-following material in the layer structure may be subjected to significantly lower thermal stress peaks. For the next-following material in the layer structure, it is thus possible to have recourse to easily and cheaply processed plastics which would per se have barely any capacity to withstand thermal stress induced by the thermal runaway.

In particular, the high heat tolerance of the carbon in the carbon layer, in particular of the graphite of the graphite film, can also have an advantageous effect on the stability of the protective element.

If the heat distributing element is or contains a metal layer and/or a carbon layer, the heat distributing element can also offer advantages, in particular, also in respect of EMC.

It may be particularly advantageous if the protective element is a multilayer protective element.

In particular, low-cost materials less capable of bearing thermal stress can advantageously be used in layers which are thermally shielded by the protective layer and the protective material contained by the protective layer.

It may be particularly advantageous if the multilayer protective element comprises the protective layer in a composite layer structure with at least one, e.g. at least two, of the following layers:
a reinforcing layer,
an application layer,
an expansion layer,
a heat distributing layer.

The reinforcing layer can preferably comprise a fiber reinforcing layer, e.g. a unidirectional fiber reinforcing layer.

Unidirectional can mean, in particular, that the fibers run substantially parallel to one another. This can preferably mean that the directions in which all the fibers extend assume an angle of less than 30°, in particular less than 20°, e.g. less than 15°, relative to one another.

The fiber reinforcing layer, e.g. the unidirectional fiber reinforcing layer, can preferably comprise a unidirectional tape (UD tape) and/or an organo sheet.

Alternatively or in addition, the reinforcing layer can comprise a metal layer. The metal layer can preferably contain a metal sheet. Thus, the reinforcing layer can, in particular, also offer advantages in terms of EMC.

The application layer can preferably comprise an adhesive material, e.g. an adhesive compound.

The expansion layer can contain the expansion zone described herein. In particular, the expansion layer can be an expansion layer containing the expansion zone described herein. The expansion zone can preferably contain the expansion material described herein that can be expanded by the action of heat.

The heat distributing layer can be, for example, a heat distributing layer containing the heat distributing element described herein.

It may be particularly advantageous if the multilayer protective element comprises the protective layer in a composite layer structure with the heat distributing layer.

It may be particularly advantageous if the multilayer protective element comprises the protective layer in a composite layer structure with the heat distributing layer and the reinforcing layer. It may be very particularly advantageous if the heat distributing layer is arranged between the protective layer and the reinforcing layer. In particular, the specific thermal conductivity of a heat distributing element contained by the heat distributing layer can be greater in the surface of the heat distributing element than in the thickness direction. For this purpose, it is possible, in particular, for the heat distributing element to contain a graphite film. This is particularly advantageous since it is then possible to use less heat-resistant materials in the reinforcing layer.

The object is achieved by an energy storage device according to the invention as claimed in the relevant independent claim.

The energy storage device comprises an electrochemical energy storage unit. It preferably comprises a multiplicity of electrochemical energy storage units.

The energy storage device comprises a protective element described herein.

The protective element is arranged on the electrochemical energy storage unit, preferably on at least some of the multiplicity of electrochemical energy storage units, e.g. on all the electrochemical energy storage units, in such a way that a hot gas stream which may escape from the electrochemical energy storage unit or from at least one of the electrochemical energy storage units during a thermal runaway impinges upon a surface of the protective element.

A casing of the electrochemical energy storage unit preferably has a yielding zone. The casing can preferably yield in the yielding zone during the thermal runaway, thus enabling hot gas that has formed to escape in a controlled manner in a predetermined direction through the yielding zone.

The casing of a multiplicity of the electrochemical energy storage units or the casing of all the electrochemical energy storage units can preferably have a yielding zone.

A yielding zone of the electrochemical energy storage unit in the energy storage device can preferably face a surface of the protective element.

It may be particularly advantageous if the protective element comprises an expansion zone described herein.

The protective element can be a protective element comprising the expansion zone described herein.

The protective element can preferably be arranged on the electrochemical energy storage unit in such a way that an expansion in the thickness direction of the protective element induced by a thermal runaway of the electrochemical energy storage unit reduces an initial spacing between the electrochemical energy storage unit and the protective element by at least 15%, preferably at least 25%, e.g. at least 40%.

The initial spacing between the electrochemical energy storage unit and the protective element is, in particular, a spacing which exists between the electrochemical energy storage unit and the protective element before the thermal runaway, that is to say before an expansion in the thickness direction of the protective element occurs.

It is surmised that the expansion in the thickness direction induced by the thermal runaway can lead to the possibility of a higher proportion of the hot gases released being received into the protective element and/or can lead to an increase in resistance to thermal conduction, thereby making it possible to hinder or prevent the thermal runaway from spreading to adjacent electrochemical energy storage units.

In this context, the expansion zone can offer the particular advantage that initially a relatively large spacing can be provided between the electrochemical energy storage unit and the protective element. As a result, in particular, more space for carrying temperature control fluids may be obtained, which can allow efficient temperature control of the electrochemical energy storage unit or of the electrochemical energy storage units in regular operation.

A relatively large initial spacing between the electrochemical energy storage unit and the protective element would promote unwanted propagation of hot gases that might be released from an electrochemical energy storage unit toward adjacent electrochemical energy storage units during the thermal runaway. In this regard, the expansion zone can provide a remedy. This is because expansion in the thickness direction of the protective element is selectively induced by the hot gases. It is thus possible preferentially for only the hot gases to be received by the protective element, whereas, during regular operation, before induced expansion, a temperature control fluid can flow between the electrochemical energy storage unit and the protective element.

Moreover, a relatively large initial spacing between the electrochemical energy storage unit and the protective element enables more installation space to be made available for the electrical contacting of the electrochemical energy storage unit or the electrochemical energy storage units.

The temperature control fluid mentioned can be gaseous.

The energy storage device can have a cooling zone. A cooling fluid, e.g. a cooling liquid, can preferably be brought into contact in the cooling zone with a surface of the electrochemical energy storage unit or surfaces of the electrochemical energy storage units. The surface can in each case be a surface of a casing of the respective electrochemical energy storage unit. The cooling zone can be delimited by a barrier from a space situated between the electrochemical energy storage unit or the electrochemical energy storage units and the protective element.

It may be particularly advantageous if the energy storage device comprises a housing.

The protective element can form at least one part of the housing or can be arranged between at least one part of the housing and the electrochemical energy storage unit or the electrochemical energy storage units.

The object is achieved by a vehicle according to the invention as claimed in the relevant independent claim.

The motor vehicle comprises an electrochemical energy storage unit serving to drive the motor vehicle. The motor vehicle can preferably comprise a multiplicity of electrochemical energy storage units serving to drive the motor vehicle.

The motor vehicle comprises the protective element described herein. The motor vehicle can comprise a plurality of protective elements, e.g. a plurality of protective elements described herein.

The protective element described herein and incorporated into the motor vehicle is arranged on the electrochemical energy storage unit in such a way that an expansion in the thickness direction of the protective element induced by a thermal runaway of the electrochemical energy storage unit can reduce an initial spacing between the electrochemical energy storage unit and the protective element by at least 15%, preferably at least 25%, e.g. at least 40%.

It is thereby possible to obtain the effects and advantages already described in the context of the energy storage device.

The protective element can advantageously be a component part of a chassis and/or a body of the motor vehicle.

It is thereby possible to eliminate a housing or part of a housing mentioned in the context of the energy storage device described herein. In particular, the protective element which is a component part of the chassis and/or the body of the motor vehicle can perform the function of the housing or the part of the housing.

If the protective element is a component part of the chassis and/or of the body of the motor vehicle, preferably at least some of the protective material, e.g. of the protective fibers, in the protective layer can be embedded in a plastic, preferably in a thermoplastic.

If the protective element is a component part of the chassis and/or of the body of the motor vehicle, the protective element can alternatively or additionally comprise a reinforcing layer. For example, the reinforcing layer can be or comprise a unidirectional reinforcing layer, preferably a unidirectional tape, an organo sheet or a metal layer. The metal layer can preferably contain a metal sheet.

Of course, features described in the context of one item according to the invention can also form features of some other item according to the invention described herein. Here, items according to the invention are, in particular, the protective element, the energy storage device and the motor vehicle.

It has been shown that the following protective materials can offer particularly good protection from electrochemical energy storage units undergoing a thermal runaway:
carbon fibers, including recycled carbon fibers,
silicate glass fibers,
basalt fibers,
aramid fibers.

Protective element samples according to the invention and protective element samples not according to the invention were tested under conditions comparable to a lithium-ion battery cell undergoing a thermal runaway.

In the case of protective element samples not according to the invention, a burnout was observed. The rear sides of the samples reached temperatures of over 800° C. within a short time.

Protective elements according to the invention contained additional recycled carbon fibers. Under otherwise identical test conditions, no burnout was observed. The temperature on the rear side of the samples rose by less than 300 K.

Further preferred features and/or advantages of the invention form the subject matter of the following description and the graphical illustration of exemplary embodiments.

### BRIEF DESCRIPTION OF THE DRAWINGS

FIG. 1: shows a section through part of a schematically illustrated energy storage device;

FIG. 2: shows a detail of the energy storage device in FIG. 1;

FIG. 3: shows a section through part of a schematically illustrated motor vehicle;

FIG. 4: shows one possibility for embodying the protective element in FIGS. 2 and 3;

FIG. 5: shows another possibility for embodying the protective element in FIGS. 2 and 3;

FIG. 6: shows another possibility for embodying the protective element in FIGS. 2 and 3;

FIG. 7: shows another possibility for embodying the protective element in FIGS. 2 and 3;

FIG. 8: shows a schematic illustration of the action of a hot gas on a protective element from FIG. 7;

FIG. 9: shows a schematic illustration of the protective element from FIGS. 7 and 8 following the action of a hot gas;

FIG. 10: shows another possibility for embodying the protective element from FIGS. 2 and 3;

FIG. 11: shows a schematic illustration of the action of a hot gas on the protective element from FIG. 10;

FIG. 12: shows a schematic illustration of the protective element from FIGS. 10 and 11 following the action of a hot gas;

FIG. 13: shows another possibility for embodying the protective element from FIGS. 2 and 3;

FIG. 14: shows a schematic illustration of the action of a hot gas on the protective element from FIG. 13;

FIG. 15: shows a schematic illustration of the protective element from FIGS. 13 and 14 following the action of a hot gas;

FIG. 16: shows a schematic illustration of a protective element precursor in the form of continuous web stock; and

FIG. 17: shows one possibility for embodying the protective element in FIGS. 2 and 3.

Elements which are identical or functionally equivalent are provided with the same reference signs in all the figures.

### DETAILED DESCRIPTION OF THE DRAWINGS

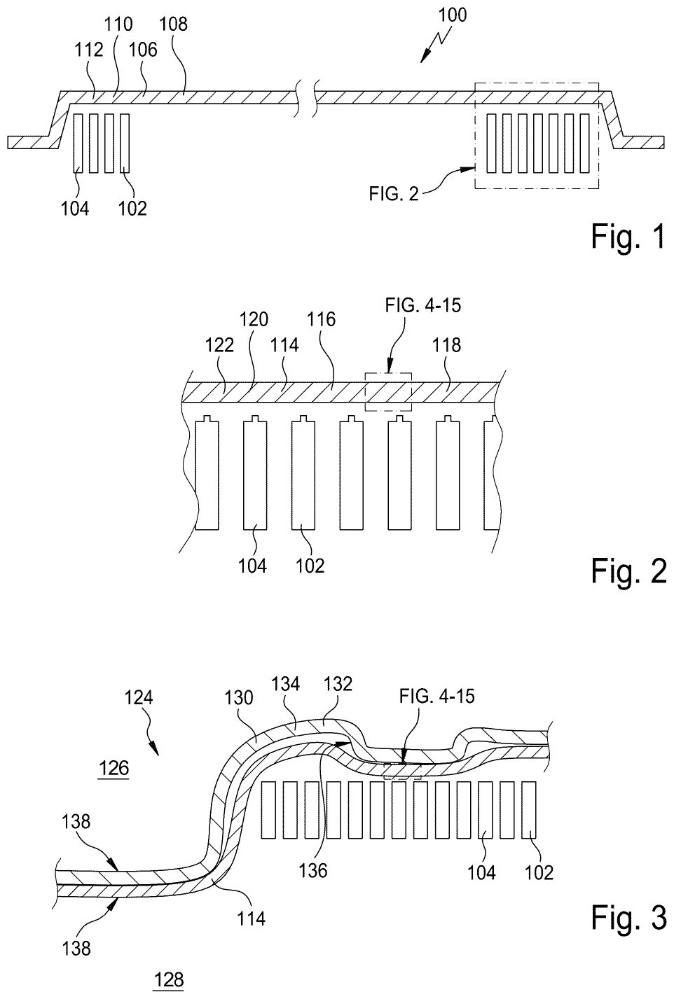

FIG. 1 shows an energy storage device 100 for a motor vehicle. The energy storage device 100 comprises a multiplicity of electrochemical energy storage units 102. In the example under consideration, the electrochemical energy storage units 102 are battery cells 104.

The energy storage device 100 comprises a housing 106. The housing 106 is a battery housing 108. In FIG. 1, only a cover element 110 of the housing 106 is illustrated. In the example shown here, the cover element 110 is a battery cover element 112.

FIG. 2 shows a detail of FIG. 1. The cover element 110 is or comprises a protective element 114. The protective element 114 is a protective element for an electrochemical energy storage unit 102. The protective element comprises a protective layer 116. The protective layer 116 is a hot gas particle stream abrasion protection layer 118.

The protective layer comprises a protective material 120. The protective material 120 is a hot gas particle stream abrasion protection material 122.

FIG. 3 shows a detail of a motor vehicle 124.

The motor vehicle 124 comprises a vehicle interior 126, which is separated entirely or partially from an energy storage compartment 128 by a motor vehicle component 130. In the example shown here, the motor vehicle component 130 is a separating element 132. The separating element 132 is a wall element 134, which extends between the vehicle interior 126 and the energy storage compartment 128.

The motor vehicle component 130 has a surface contour 136 facing the energy storage compartment 128.

The motor vehicle 124 comprises a protective element 114. A surface 138 of the protective element 114 faces a multiplicity of electrochemical energy storage units 102. The electrochemical energy storage units 102 are battery cells 104. The electrochemical energy storage units 102 serve to drive the motor vehicle 124. The protective element 114 is arranged on the electrochemical energy storage units 102 in such a way that a hot gas stream which may escape from the electrochemical energy storage units during a thermal runaway impinges upon the surface 138 of the protective element 114. A flexible protective element 114, which follows the surface contour 136 of the motor vehicle component 130, is shown.

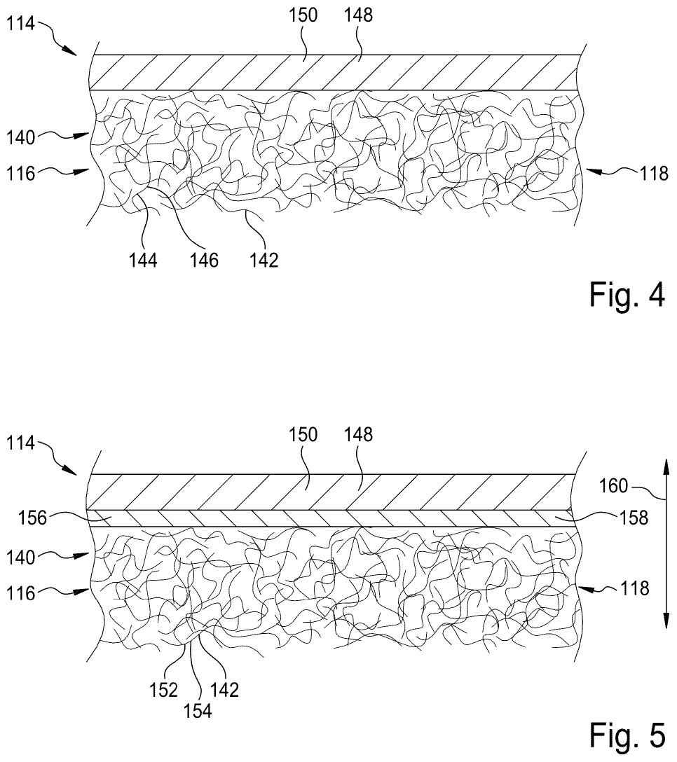

FIGS. 4 to 15 and 17 illustrate by way of example details of protective elements 114 and protective layers 116, which are shown in FIGS. 2 and 3.

FIG. 4 shows a detail of a protective element 114. The protective element 114 comprises a protective layer 116. The protective layer 116 is a nonwoven 140. The protective layer 116 comprises protective fibers 142. The protective fibers are carbon fibers 144, wherein these may be recycled carbon fibers 146, for example. The protective layer 116 acts as a hot gas particle stream abrasion protection layer 118. In this context, the protective fibers 142 act as a protective material 120, in particular as a hot gas particle stream abrasion protection material 122.

The protective element 114 shown in FIG. 4 is a multilayer protective element. The multilayer protective element comprises the protective layer 116 in a composite layer structure with a reinforcing layer 148. The reinforcing layer 148 can be a fiber reinforcing layer 150, for example. In particular, the fiber reinforcing layer 150 can be reinforced by fibers.

FIG. 5 shows a detail of a protective element 114. The protective element 114 shown in FIG. 5 is also a multilayer protective element. It differs from the protective element illustrated in FIG. 4 in that the protective fibers 142 are mineral fibers 152. In the example shown here, mineral fibers 152 are basalt fibers 154.

Another difference in the protective element shown in FIG. 5 from the protective element shown in FIG. 4 is that a heat distributing layer 156 is arranged between the protective layer 116 and the reinforcing layer 148. The heat distributing layer 156 comprises a heat distributing element, which may be a graphite film 158, for example. The graphite film 158 contains a graphite expandate partially compressed in the thickness direction 160 of the protective element 114. Consequently, the specific thermal conductivity of the heat distributing layer 156 is anisotropic. In the thickness direction, the specific thermal conductivity of the heat distributing layer 156 is lower than orthogonally to the thickness direction in the plane of the graphite film. The anisotropy of the specific thermal conductivity may be particularly advantageous in the context of the thermal runaway of electrochemical energy storage units 102. Heat acting at individual points on the heat distributing layer 156 on the protective-layer side is distributed over a large area within the heat distributing layer, and it is therefore also possible to use materials with a low heat resistance on the reinforcing-layer side. In particular, this may open up possibilities for manufacturing protective elements according to the invention in a particularly efficient way and from lightweight materials.

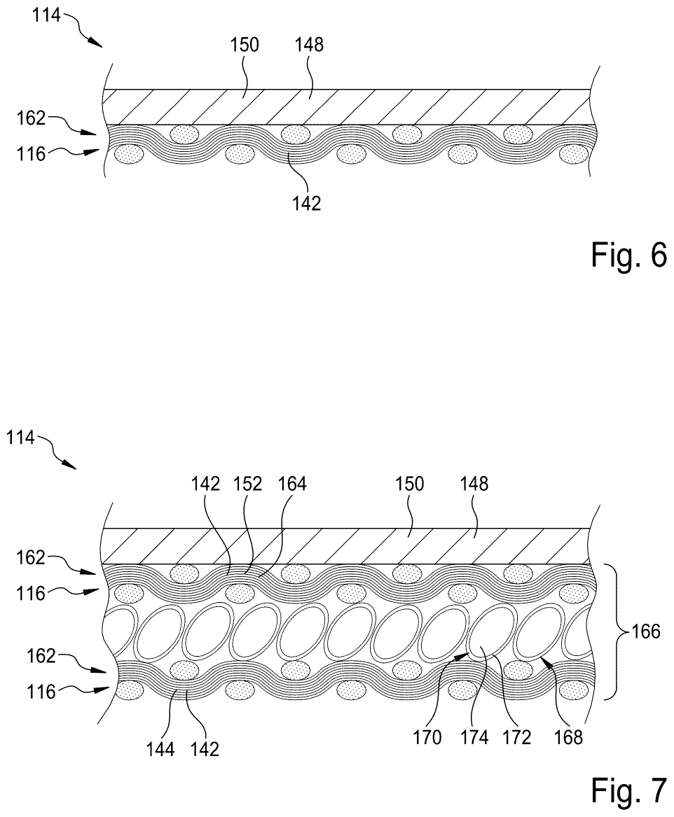

FIG. 6 shows another detail of a protective element 114. The protective element 114 shown in FIG. 6 is also a multilayer protective element. It comprises a protective layer 116. The protective layer 116 is a woven fabric 162. The woven fabric 162 can be formed from protective fibers 142.

The protective element 114 also comprises a reinforcing layer 148, wherein this may be a fiber reinforcing layer 150.

FIG. 7 shows another detail of a protective element 114. The protective element shown in FIG. 7 is also a multilayer protective element. It comprises two protective layers 116. The two protective layers 116 are woven fabrics 162.

The protective element 114 also comprises a reinforcing layer 148, which may be a fiber reinforcing layer 150, for example.

One of the protective layers 116 is arranged directly adjacent to the reinforcing layer 148. It comprises protective fibers 142. The protective fibers 142 are mineral fibers 152, e.g. glass fibers 164.

The other protective layer 116 also comprises protective fibers 142. The protective fibers 142 are carbon fibers 144, e.g. recycled carbon fibers 146.

The protective element 114 comprises an expansion zone 166. The protective element is expandable in the expansion zone 166. It is expandable in the expansion zone 166 by the action of heat. In the expansion zone, the protective element contains an expansion material 168 that can be expanded by the action of heat. In FIG. 7, the expansion material is illustrated in simplified form as capsules 170 arranged side-by-side. The capsules each comprise a casing 172 and a propellant 174 enclosed by the casing 172.

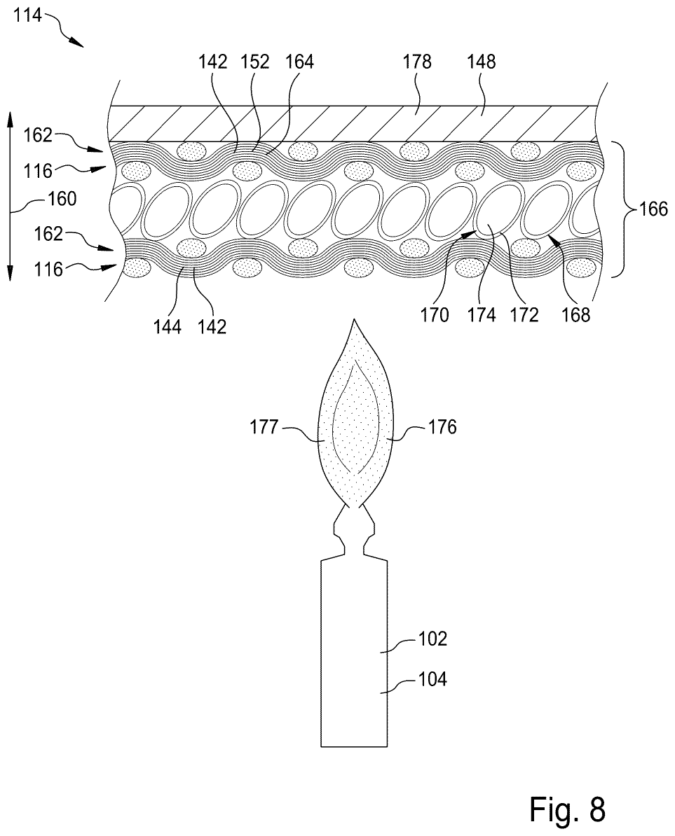

FIG. 8 shows the action of a hot gas 176 on a protective element 114 illustrated in FIG. 7. FIG. 8 furthermore indicates that the reinforcing layer 148 may be a metal sheet 178 or that the reinforcing layer 148 may contain a metal sheet 178. The hot gas 176 is escaping from an electrochemical energy storage unit 102, which may be a battery cell 104, for example. The hot gas 176 contains particles 177 and can thus also, in particular, have an abrasive effect.

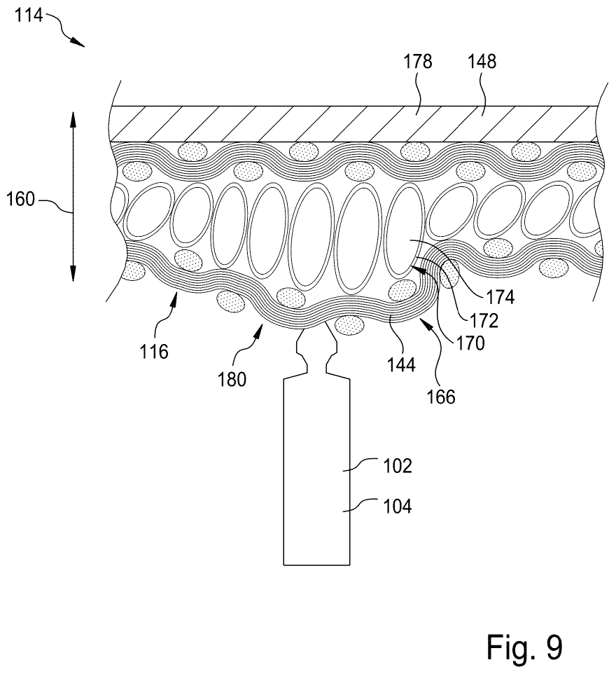

FIG. 9 shows an expanded state of the protective element from FIGS. 7 and 8, which the protective element 114 has adopted after expansion due to the action of heat.

FIG. 9 shows, in particular, that the expansion zone 166 is in the form of an expanded expansion zone 166. The propellant 174 in the capsules 170 takes up a larger volume within the casings 172. FIG. 9 represents the actual condition of the expansion zone 166 in a greatly simplified form. Owing to the immense heat that escapes from a battery cell 104 during the thermal runaway, a large proportion of the capsules 170 burst and, after initial inflation of the casings 172, the propellant 174 emerges from the capsules 170. Nevertheless, the bulge 180 illustrated in FIG. 9 may form, bringing the protective layer 116 facing the electrochemical energy storage unit 102 or battery cell 104 close to the electrochemical energy storage unit 102 or battery cell 104.

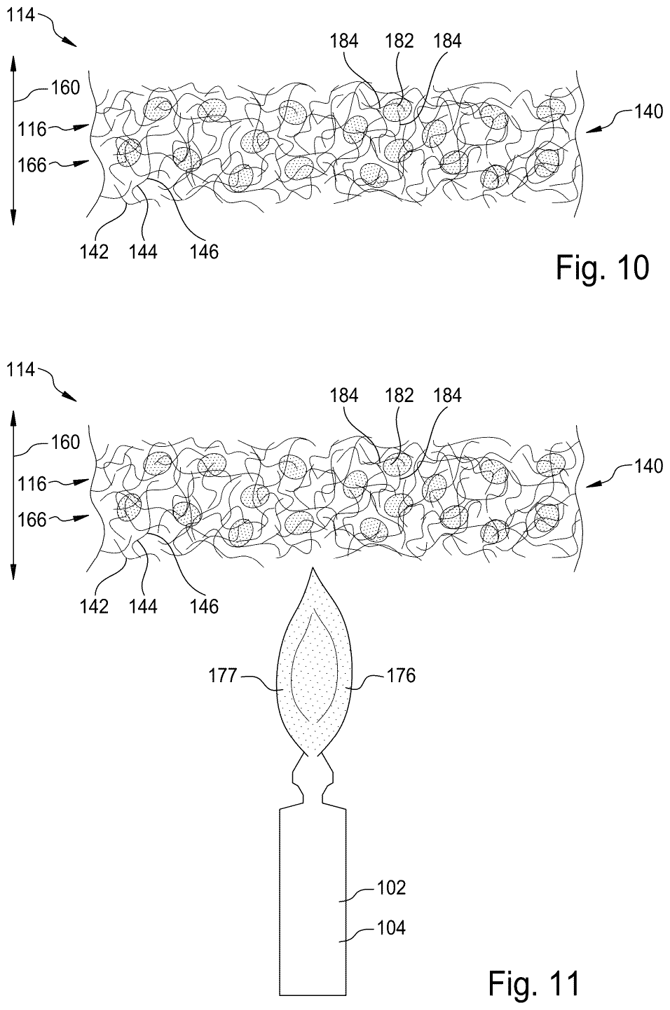

FIG. 10 likewise shows a detail of a protective element 114, wherein only the protective layer 116 contained by the protective element 114 is illustrated. The protective layer 116 is a nonwoven 140. It contains protective fibers 142 acting as a protective material 120. The protective fibers 142 are carbon fibers 144, wherein these may be recycled carbon fibers 146, for example.

In the protective element 114 shown in FIG. 10, the protective layer 116 comprises an expansion zone 166. In the expansion zone 166, the protective layer is expandable. The protective layer 116 is expandable in the thickness direction 160 of the protective element 114 by the action of heat. In the expansion zone 166, the protective layer 116 is held in a state of compression in the thickness direction 160. The compressed state is maintained by a heat-sensitive material 182. In the thickness direction 160, the expansion of the protective layer 116 can be achieved by the action of heat on the heat-sensitive material 182.

In the nonwoven 140, the compressed state, i.e. the state of compression in the thickness direction 160, is maintained by the fact that the heat-sensitive material 182 joins together fiber portions 184 of the nonwoven 140 in a state of compression in the thickness direction. When the heat-sensitive material 182 melts or pyrolyzes on account of the action of heat, the nonwoven 140 changes to a decompressed state, wherein restoring forces may act. The restoring forces may be, in particular, restoring forces which can be released by fibers that have been held in a prestressed state by the heat-sensitive material.

FIG. 11 corresponds to FIG. 8 but, instead of the protective element 114 from FIG. 7, FIG. 11 shows the protective element 114 from FIG. 10.

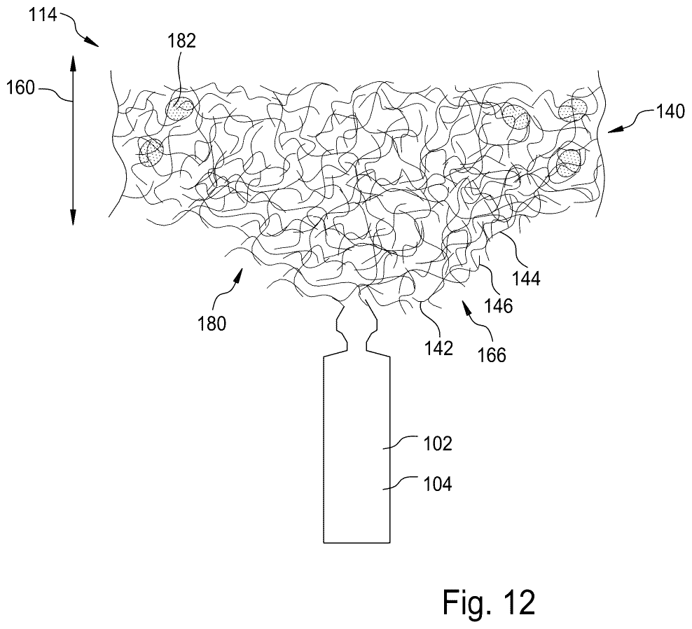

The action of heat illustrated in FIG. 11 may result in the state illustrated in FIG. 12. In a central region of the nonwoven 140, which is illustrated above the electrochemical energy storage unit 102 in FIG. 12, there is no longer any heat-sensitive material 182 present. This is because the heat-sensitive material 182 has been melted and/or vaporized there by the action of heat. Owing to the described effect of the restoring forces, a bulge 180 has formed in the region above the electrochemical energy storage unit 102. There, protective fibers 142 extend close to the burst electrochemical energy storage unit 102.

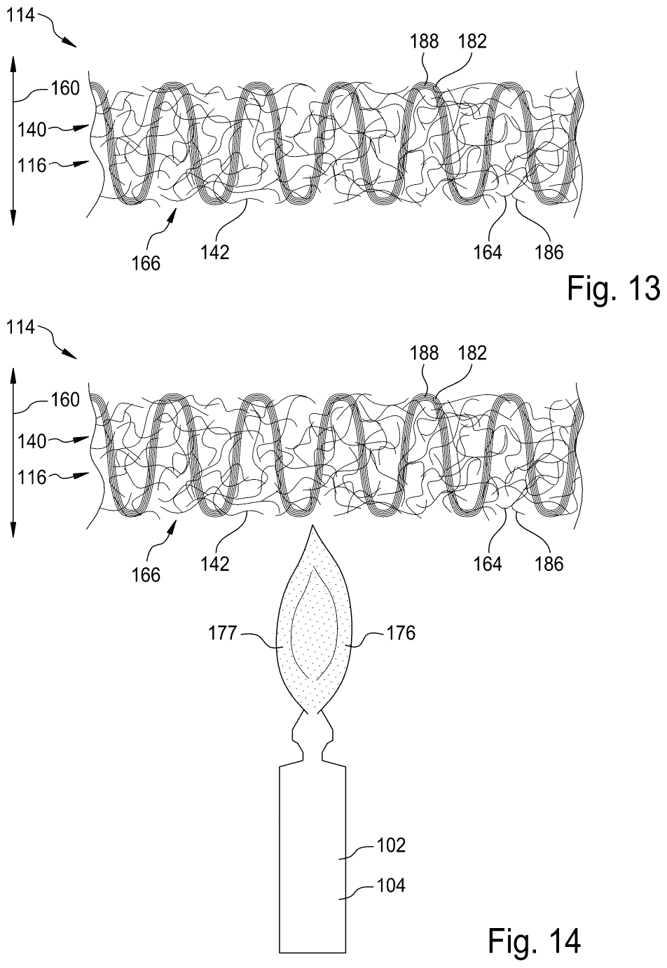

FIG. 13 shows a detail of another protective element 114, comprising a protective layer 116. The protective layer 116 is a nonwoven 140, wherein the nonwoven contains glass fibers 164 as protective fibers 142. The glass fibers 164 are glass fibers made of quartz glass 186.

In the expansion zone 166, the protective layer 116 illustrated in FIG. 13 is held in a state of compression in the thickness direction 160 by a heat-sensitive material 182.

In the case of the protective layer 116 shown in FIG. 13, the heat-sensitive material 182 is in the form of a heat-sensitive thread element 188. The state of compression in the thickness direction 160 is maintained by the fact that the heat-sensitive thread element 188 is passed through the nonwoven 140 in the thickness direction, e.g. being passed forward and backward in the thickness direction 160, as illustrated in FIG. 13.

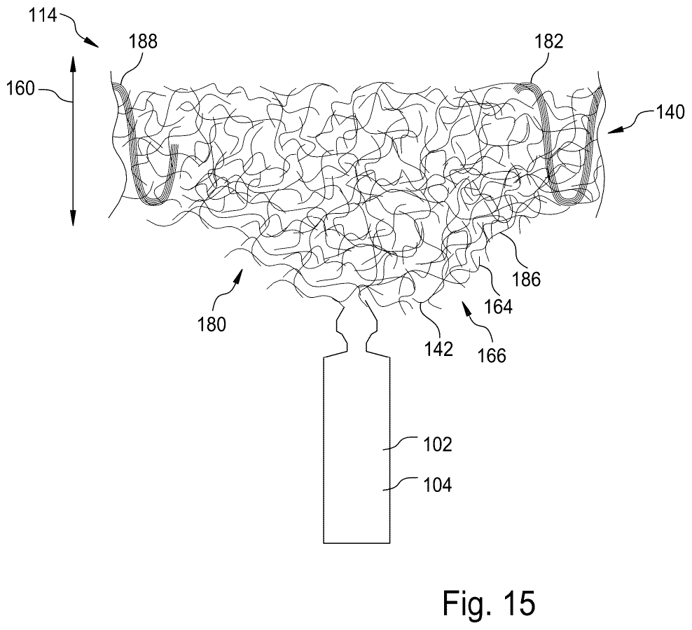

The action of hot gas 176 illustrated in FIG. 14 then results in similar effects to those previously illustrated in FIGS. 11 and 12 for the protective element from FIG. 10. Where the hot gas 176 acts, the heat-sensitive thread element 188 melts, causing the protective layer 116 to change to an expanded state. During this process, the bulge 180, already shown in FIGS. 9 and 12, is formed (FIG. 15).

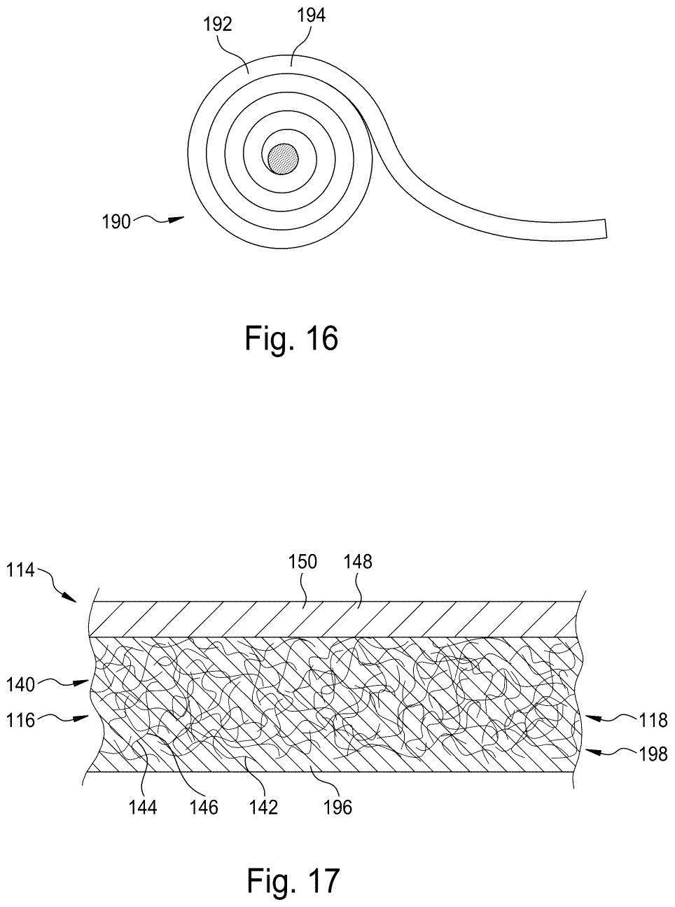

FIG. 16 shows a protective element precursor 194 in the form of a roll 190 as continuous web stock 192.

The protective element 114 shown in FIG. 17 is a multilayer protective element. The multilayer protective element comprises the protective layer 116 in a composite layer structure with a reinforcing layer 148. The reinforcing layer 148 can be a fiber reinforcing layer 150, for example. In particular, the fiber reinforcing layer 150 can be reinforced by fibers. The protective fibers 142 are carbon fibers 144, e.g. recycled carbon fibers. They are incorporated into a fiber protection matrix 198. The protective fibers do not reach as far as the surface but are covered by an insulation zone 196. The insulation zone 196 can provide protection, in particular, from contact with oxygen and from the risk of an electric arc effect which may exist on account of the electrical conductivity of the carbon fibers.

The protective element precursor 194 can be a multilayer protective element precursor 194, wherein the layer structure can correspond, for example, to the layer structure illustrated in FIGS. 4 and 5. Of course, the reinforcing layer 148 in the case of continuous web stock 192 must be sufficiently flexible to be rolled up onto a roll 190.

Cut sections of the protective element precursor 194 can be used as protective element 114. They can be arranged between a motor vehicle component 130 and energy storage units 102 as illustrated in FIG. 3, for example.

If, in contrast, the protective element 114 is intended to be a wall of a housing 106, as shown, for example, in FIG. 2, wall-type reinforcing layers 148 are preferably produced. For this purpose, reinforcing layers can contain metal sheets or organo sheets.

### LIST OF REFERENCE SIGNS

100 energy storage device
102 electrochemical energy storage unit
104 battery cell
106 housing
108 battery housing
110 cover element
112 battery cover element
114 protective element
116 protective layer
118 hot gas particle stream abrasion protection layer
120 protective material
122 hot gas particle stream abrasion protection material
124 motor vehicle
126 vehicle interior
128 energy storage space
130 motor vehicle component
132 separating element
134 wall element
136 surface contour
138 surface
140 nonwoven
142 protective fiber
144 carbon fiber
146 recycled carbon fiber
148 reinforcing layer
150 fiber reinforcing layer
152 mineral fiber
154 basalt fiber
156 heat distributing layer
158 graphite film
160 thickness direction
162 woven fabric
164 glass fiber
166 expansion zone
168 expansion material
170 capsule
172 casing
174 propellant
176 hot gas
177 particle
178 metal sheet
180 bulge
182 heat-sensitive material
184 fiber portion
186 quartz glass
188 heat-sensitive thread element
190 roll
192 continuous web stock
194 protective element precursor
196 insulation zone
198 fiber protection matrix

1. A protective element for an electrochemical energy storage unit or for a battery cell,
wherein the protective element comprises the following:
a protective layer or a hot gas particle stream abrasion protection layer, wherein the protective layer comprises a protective material or a hot gas particle stream abrasion protection material.

2. The protective element as claimed in claim 1,
wherein
the protective material contains protective fibers or protective fibers which are resistant to a hot gas particle stream,
wherein the protective fibers are preferably high-temperature-stable,
wherein the high-temperature-stable protective fibers are preferably stable at a melting temperature of glass fibers or at 1150° C.

3. The protective element as claimed in claim 2,
wherein
the protective fibers are selected from among mineral fibers and carbon fibers.

4. The protective element as claimed in claim 3,
wherein
the mineral fibers are selected from among
fibers made from a glass,
fibers made from rock,
fibers made from slag,
silica fibers,
fibrous single crystals, and
ceramic fibers.

5. The protective element as claimed in claim 3,
wherein
the mineral fibers are selected from among
fibers made from at least one of the following glasses:
S-glass,
R-glass,
C-glass,
ECR-glass,
AR-glass and
Q-glass
and
basalt fibers.

6. The protective element as claimed in claim 2,
wherein
the protective fibers are selected from among recycled carbon fibers.

7. The protective element as claimed in claim 2,
wherein
the protective element contains additional fibers, wherein the temperature stability of the additional fibers is lower than the temperature stability of the protective fibers.

8. The protective element as claimed in claim 7,
wherein
the additional fibers are glass fibers or are made from E-glass and/or ECR-glass.

9. The protective element as claimed in claim 1,
wherein
the protective layer is a fiber layer.

10. The protective element as claimed in claim 1,
wherein
the protective layer or the fiber layer, comprises a regular sheet-like fibrous structure or an irregular sheet-like fibrous structure.

11. The protective element as claimed in claim 1,
wherein
the protective layer or the fiber layer, comprises a non-crimp fabric, a woven fabric, a knitted fabric, a mat or a nonwoven.

12. The protective element as claimed in claim 1,
wherein
at least some of the protective material or of the protective fibers, in the protective layer is embedded in a plastic or in a thermoplastic,
wherein the protective element or the protective layer can be shapable in a heated state.

13. The protective element as claimed in claim 1,
wherein
the protective element or the protective layer, comprises the following:
an expansion zone,
wherein the protective element or the protective layer, is expandable in the expansion zone, and/or wherein the protective element is expandable in the expansion zone by the action of heat.

14. The protective element as claimed in claim 13,
wherein
the protective element or the protective layer, is held in a compressed state in the thickness direction in the expansion zone, and/or
wherein the compressed state is maintained by a heat-sensitive material.

15. The protective element as claimed in claim 13,
wherein
the protective layer comprises the nonwoven, wherein the compressed state or the state of compression in the thickness direction, is maintained by means of the fact that the heat-sensitive material joins together fiber portions of the nonwoven in the compressed state, and/or is maintained by the fact that the heat-sensitive material is passed through the nonwoven in the thickness direction, and/or is passed forward and backward in the thickness direction.

16. The protective element as claimed in claim 13,
wherein
in the expansion zone, the protective element contains an expansion material that can be expanded by the action of heat,
wherein expansion of the protective element in the thickness direction can be achievable by the action of heat on the expandable expansion material.

17. The protective element as claimed in claim 16,
wherein
the expandable expansion material comprises an encapsulated propellant or consists of the encapsulated propellant.

18. The protective element as claimed in claim 1,
wherein
the protective element comprises a heat distributing element or a sheet-like heat distributing element or a sheet-like heat distributing element aligned parallel to the protective layer.

19. The protective element as claimed in claim 18,
wherein
the heat distributing element is or contains a metal layer and/or a carbon layer.

20. The protective element as claimed in claim 18,
wherein
a specific thermal conductivity of the sheet-like heat distributing element is greater in the surface of the heat distributing element than in the thickness direction,
wherein the heat distributing element preferably is or contains a carbon layer,
wherein the carbon layer preferably contains a graphite expandate partially compressed in the thickness direction, and/or
wherein the carbon layer is or contains a graphite film.

21. The protective element as claimed in claim 1,
wherein
the protective element is a multilayer protective element.

22. The protective element as claimed in claim 21,
wherein
the multilayer protective element comprises the protective layer in a composite layer structure with at least one or at least two, of the following layers:
a reinforcing layer, or
a unidirectional fiber reinforcing layer, or a unidirectional tape or organo sheet, or
a metal layer, or a metal sheet, or
an application layer, or
an application layer which comprises an adhesive material, or an adhesive compound, or
an expansion layer, or
an expansion layer containing an expansion zone, wherein the expansion zone contains an expansion material that can be expanded by the action of heat, or
a heat distributing layer, or
a heat distributing layer containing a heat distributing element.

23. An energy storage device, comprising:
an electrochemical energy storage unit, or a multiplicity of electrochemical energy storage units, and
a protective element as claimed in claim 1,
wherein the protective element is arranged on the electrochemical energy storage unit in such a way that a hot gas stream which may escape from the electrochemical energy storage unit during a thermal runaway impinges upon a surface of the protective element.

24. The energy storage device as claimed in claim 23,
wherein
the protective element is a protective element, comprising an expansion zone, wherein the protective element is arranged on the electrochemical energy storage unit in such a way that an expansion in the thickness direction of the protective element induced by a thermal runaway of the electrochemical energy storage unit reduces an initial spacing between the electrochemical energy storage unit and the protective element by at least 15%, or at least 25%, or at least 40%.

25. The energy storage device as claimed in claim 23,
wherein
the energy storage device comprises a housing,
wherein the protective element forms at least one part of the housing or is arranged between at least one part of the housing and the electrochemical energy storage unit.

26. A motor vehicle comprising:
an electrochemical energy storage unit serving to drive the motor vehicle, or a multiplicity of electrochemical energy storage units serving to drive the motor vehicle, and
a protective element for an electrochemical energy storage unit, or for a battery cell,
wherein the protective element comprises a protective layer, or a hot gas particle stream abrasion protection layer, wherein the protective layer comprises a protective material, or a hot gas particle stream abrasion protection material,
wherein the protective element is arranged on the electrochemical energy storage unit in such a way that an expansion in the thickness direction of the protective element induced by a thermal runaway of the electrochemical energy storage unit reduces an initial spacing between the electrochemical energy storage unit and the protective element by at least 15%, or at least 25%, or at least 40%.

27. The motor vehicle as claimed in claim 26,
wherein
the protective element is a component part of a chassis and/or a body of the motor vehicle, or
wherein at least some of the protective material, or of the protective fibers, in the protective layer is embedded in a plastic, or in a thermoplastic,
and/or
wherein the protective layer comprises a reinforcing layer, or a unidirectional fiber reinforcing layer, or a unidirectional tape, an organo sheet or a metal layer,
wherein the metal layer can preferably contain a metal sheet.
